(19) United States
(12) Patent Application Publication
(10) Pub. No.: US 2021/0182518 A1
(43) Pub. Date: Jun. 17, 2021

(54) PRODUCT ANTI-COUNTERFEITING METHOD AND SYSTEM BASED ON MATERIAL SIGNATURE BLOCKCHAIN

(71) Applicant: GUANGDONG UNIVERSITY OF TECHNOLOGY, GUANGZHOU (CN)

(72) Inventors: Jiewu LENG, GUANGZHOU (CN); Man ZHOU, GUANGZHOU (CN); Qiang LIU, GUANGZHOU (CN); Longzhang LI, GUANGZHOU (CN); Jianbo JING, GUANGZHOU (CN); Shide YE, GUANGZHOU (CN); Zhangyi WANG, GUANGZHOU (CN)

(21) Appl. No.: 17/037,630

(22) Filed: Sep. 29, 2020

(30) Foreign Application Priority Data
Dec. 17, 2019 (CN) 201911303392.8

(51) Int. Cl. G06K 7/14; G06F 16/955; G06F 16/953; G06F 21/60; G06K 19/06

(52) U.S. Cl. CPC G06K 7/1417; G06F 16/9554; G06K 19/06037; G06F 21/602; G06F 16/953

(57) ABSTRACT

A product anti-counterfeiting method based on a material signature blockchain. The method includes chaining of signature information and product information, QR code generation, query of on-chain information, and offline inspection. Also disclosed is an anti-counterfeiting system of the product anti-counterfeiting method based on a material signature blockchain. The system includes a product material signature module, a module of chaining signature information and product information, a module of generating a QR code, a module of querying on-chain information, and an offline inspecting module. The present invention proposes a product anti-counterfeiting method and a system based on a material signature blockchain according to the above content, which uses the material signature technology to solve the problem of the authenticity of the off-chain product.

### CROSS-REFERENCE TO RELATED APPLICATIONS

This application claims priority to Chinese Patent Application No. 201911303392.8 with a filing date of Dec. 17, 2019. The content of the aforementioned applications, including any intervening amendments thereto, are incorporated herein by reference.

### TECHNICAL FIELD

The present invention relates to the technical field of product verification, and more specifically to a product anti-counterfeiting method and a system based on a material signature blockchain.

### BACKGROUND

As an emerging technology, the blockchain is increasingly used in real life due to its traceability and tamper-proof characteristics. How to prevent product fraud has been a hot topic for a long time. Finding an effective way to prevent product fraud is of great significance to the development of enterprises.

Traditional product verification is based on the manufacturing company as the center for product verification. However, the lack of third-party supervision and the collapse of the center will cause the entire system to collapse, such as the famous computer virus incident in TSMC. A computer in the center of the enterprise fails so that the entire system of the enterprise collapses, resulting in great losses. Although there are many product traceability verifications based on blockchain technology, the verification system has many problems that need to be solved urgently.

### SUMMARY

The object of the present invention is to propose a product anti-counterfeiting method and a system based on a material signature blockchain, which uses the material signature technology to solve the problem of the authenticity of the off-chain product; uses the blockchain technology to ensure the authenticity of uploading the on-chain information; uses the QR code technology to solve the problem of disconnection between the on-chain information and the off-chain information, and establishes a firm connection between the off-chain products and the on-chain information.

To achieve this object, the present invention adopts the following technical solutions.

A product anti-counterfeiting method based on a material signature blockchain is provided. The method includes product material signature: chemically labeling a product;

chaining of signature information and product information: detecting the signature information of the product, storing the signature information in the blockchain, and storing the product information of the product in the blockchain;

generation of a QR code: after the signature information and the product information are chained, generating a QR code of the product, and engraving the QR code on a certain part of the product;

query of on-chain information: the data stored in the blockchain comprises public data and private data, on-chain users are capable of querying the public data, and on-chain users are capable of querying the private data after being authorized;

offline inspection: obtaining the signature information of the product offline, and comparing the signature information of the product obtained offline with the signature information of the product queried by the user on the chain to verify the authenticity.

Further, in the material signature step of the product, a graphene labeling method or a carbon dot labeling method is used to chemically label the product.

Further, the blockchain is a consortium blockchain.

Further, in the QR code generating step, after the signature information and the product information are chained, a smart contract deployed on a blockchain network automatically generates a QR code.

An anti-counterfeiting system for a product anti-counterfeiting method based on a material signature blockchain comprises a product material signature module, a module of chaining signature information and product information, a module of generating a QR code, a module of querying on-chain information, and an offline inspecting module;

the product material signature module is configured to chemically label a product;

the module of chaining signature information and product information is configured to detect the signature information of the product, store the signature information in the blockchain, and store the product information of the product in the blockchain;

the module of generating a QR code is configured to, after the signature information and the product information are chained, generate a QR code of the product, and engrave the QR code on a certain part of the product;

the module of querying on-chain information is configured to query the public data by on-chain users and query the private data by on-chain users after being authorized;

the offline inspecting module is configured to obtain the signature information of the product offline, and compare the signature information of the product obtained offline with the signature information of the product queried by the user on the chain to verify the authenticity.

Further, the product material signature module uses a graphene labeling method or a carbon dot labeling method to chemically label the product.

Further, the blockchain is a consortium blockchain.

Further, the module of generating a QR code comprises a smart contract deployed on a blockchain network.

The present invention proposes a product anti-counterfeiting method and a system based on a material signature blockchain according to the above content, which uses the material signature technology to solve the problem of the authenticity of the off-chain product; uses the blockchain technology to ensure the authenticity of uploading the on-chain information; uses the QR code technology to solve the problem of disconnection between the on-chain information and the off-chain information, and establishes a firm connection between the off-chain products and the on-chain information.

The chemically labeling material manner is used to label the manufactured products, and chemical characteristics are used to ensure the uniqueness of the product, so that it can ensure the authenticity of the product when it is chained.

The QR code technology is used as a link bridge, and the QR code is used as a link to combine the on-chain information on the blockchain with the off-chain products to form a complete system. When users scan and view private data, they need to log on to the consortium blockchain, and only can view it with the appropriate permissions.

The blockchain, QR code, and chemically labeling are combined to form a complete system from off-chain to on-chain, giving full play to the advantages of each technology and ensuring the authenticity of products.

### BRIEF DESCRIPTION OF THE DRAWINGS

FIG. 1 is a system block diagram of one embodiment of the present invention.

### DESCRIPTION OF THE EMBODIMENTS

The technical solutions of the present invention will be further described hereinafter in conjunction with the drawings and specific implementations.

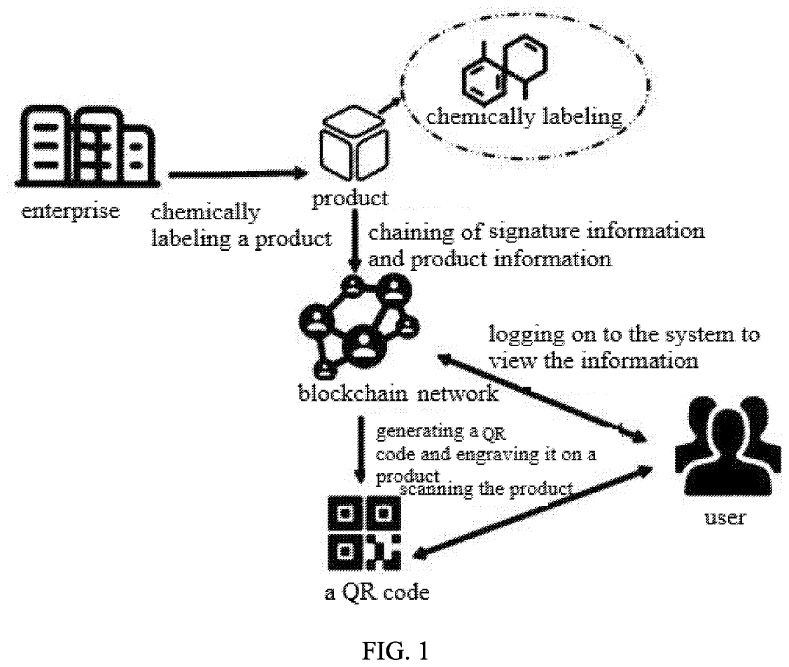

As shown in FIG. 1, a product anti-counterfeiting method based on a material signature blockchain of this embodiment is provided on the premise that the blockchain is a special distributed database, which performs a point-to-point transaction. The entire network consists of many points. Data is stored at various points, which is a network without a center. When constructing a product verification system, a blockchain network needs to be constructed to attribute different users to different nodes.

The anti-counterfeiting method comprises the following steps.

Product material signature: a product is chemically labeled; the specific process is as follows: when the product is completed, the key part of the product is chemically labeled, and the product can be uniquely represented by the use of the chemically labeling technology to ensure the uniqueness of the product. Specifically, a graphene labeling method or a carbon dot labeling method can be used to chemically label the product. The use of the graphene or carbon dot labeling method can create an atomic-level unique identifier that cannot be reproduced so that the labeled product is unique. In addition, the labeling elements do not affect the appearance of the product and the use of normal functions.

Chaining of signature information and product information: the signature information of the product is detected through a chemically labeling detection device, the signature information is stored in the blockchain, the signature information is made into a string of information so that it is used the unique identifier of the product, the product information of the product is stored in the blockchain, and the association of the label information with the product information can guarantee the uniqueness of each product.

Generation of a QR code: after the signature information and the product information are chained, the smart contract deployed on the blockchain network (a smart contract is a computer protocol designed to spread, verify or execute the contract in an information-based manner) will automatically generate a QR code, and the manufacturer will engrave the QR code on a certain part of the product; when the user views the QR code, the general public information can be viewed. If the user wants to view private data, the user can only view the corresponding information after logging on to the system and obtaining the corresponding permissions.

Query of on-chain information: the blockchain in this embodiment is a consortium blockchain (the consortium blockchain is a blockchain managed by a specific organization and is partially decentralized), and the consortium blockchain is used to manage data. The data of the consortium blockchain comprises public data and private data, and the data that does not need to be kept secret in product data is made into the public data, which can be queried and accessed by the on-chain users; some key information is subjected to privacy protection processing, such as making the signature information into private data. After the on-chain users are authorized, they can view private data.

Offline inspection: the signature information of the product is obtained offline through a corresponding device, and the signature information of the product obtained offline is compared with the signature information of the product queried by the user on the chain to verify the authenticity.

The entire system traceable for product information verification consists of traceability centers, manufacturers, distributors, consumers, and time stamp servers; manufacturers and distributors generate production records, warehousing records, outgoing records, logistics records, and dealer records of goods; and the traceability center completes the verification and preservation of records; it is convenient for consumers to trace the source of product information.

The introduction of the blockchain technology and third-party time stamp servers makes all traceability records of goods immutable and undeniable. However, the existing methods still have huge problems in solving the authenticity of off-chain products, and can only guarantee the authenticity and non-tampering of the on-chain information. The QR code also has the risk of being replaced, so that the on-chain and off-chain products exist in isolation from each other and cannot form an effective entirety.

In the operation of an enterprise, data is divided into public data and private data. Public data can be viewed by users participating in the network, while private data can only be known after specific users are authorized. The existing technology does not distinguish between product data, and users who log on to the network can view all product-related information, and there is a risk of information leakage for enterprises. Therefore, product information security is also a problem to be solved.

The present invention uses a graphene or carbon dot labeling method for offline products to label key parts of related products. The use of graphene and carbon dot labeling method can create an atomic-level unique identifier that cannot be reproduced so that the labeled product is unique. In addition, the labeling elements do not affect the appearance of the product and the use of normal functions.

The material signature technology is used to ensure the uniqueness of the product, the product information and the signature information are chained, and then a QR code is generated, which is engraved on the part of the product which is difficult to disassemble. The present invention can guarantee the authenticity of off-chain products, and realize the combination of on-chain and off-chain information through the QR code technology, so that originally isolated information can be combined to form a complete network and reduce losses caused by trust problems. It is convenient for users to query the corresponding public data through the QR code. Further viewing of private data requires the authorization of the product manufacturer to ensure the security of product information. When verifying the authenticity of the information, the corresponding device is used to obtain the chemically signature information, and the information is compared with the on-chain information to verify the authenticity.

Therefore, through an anti-counterfeiting system for a product anti-counterfeiting method based on a material signature blockchain of the present invention, the off-chain product and the on-chain data can be combined, and the association of the product with the on-chain data can be established through the QR code engraved on the product so as to avoid isolated on-chain information. The chemically labeling material manner is used to ensure the authenticity and uniqueness of the offline products.

The chemically labeling material manner is used to label the manufactured products, and chemical characteristics are used to ensure the uniqueness of the product, so that it can ensure the authenticity of the product when it is chained.

The QR code technology is used as a link bridge, and the QR code is used as a link to combine the on-chain information on the blockchain with the off-chain products to form a complete system. When users scan and view private data, they need to log on to the consortium blockchain, and only can view it with the appropriate permissions.

The blockchain, QR code, and chemically labeling are combined to form a complete system from off-chain to on-chain, giving full play to the advantages of each technology and ensuring the authenticity of products.

An anti-counterfeiting system for a product anti-counterfeiting method based on a material signature blockchain of this embodiment is provided on the premise that the blockchain is a special distributed database, which performs a point-to-point transaction. The entire network consists of many points. Data is stored at various points, which is a network without a center. When constructing a product verification system, a blockchain network needs to be constructed to attribute different users to different nodes.

An anti-counterfeiting system for a product anti-counterfeiting method based on a material signature blockchain comprises a product material signature module, a module of chaining signature information and product information, a module of generating a QR code, a module of querying on-chain information, and an offline inspecting module;

the product material signature module is configured to chemically label a product;

the module of chaining signature information and product information is configured to detect the signature information of the product, store the signature information in the blockchain, and store the product information of the product in the blockchain;

the module of generating a QR code is configured to, after the signature information and the product information are chained, generate a QR code of the product, and engrave the QR code on a certain part of the product;

the module of querying on-chain information is configured to query the public data by on-chain users and query the private data by on-chain users after being authorized;

the offline inspecting module is configured to obtain the signature information of the product offline, and compare the signature information of the product obtained offline with the signature information of the product queried by the user on the chain to verify the authenticity.

Further, the product material signature module uses a graphene labeling method or a carbon dot labeling method to chemically label the product.

Further, the blockchain is a consortium blockchain.

Further, the module of generating a QR code comprises a smart contract deployed on a blockchain network.

The entire system traceable for product information verification consists of traceability centers, manufacturers, distributors, consumers, and time stamp servers; manufacturers and distributors generate production records, warehousing records, outgoing records, logistics records, and dealer records of goods; and the traceability center completes the verification and preservation of records; it is convenient for consumers to trace the source of product information.

The introduction of the blockchain technology and third-party timestamp servers makes all traceability records of goods immutable and undeniable. However, the existing methods still have huge problems in solving the authenticity of off-chain products, and can only guarantee the authenticity and non-tampering of the on-chain information. The QR code also has the risk of being replaced, so that the on-chain and off-chain products exist in isolation from each other and cannot form an effective entirety.

In the operation of an enterprise, data is divided into public data and private data. Public data can be viewed by users participating in the network, while private data can only be known after specific users are authorized. The existing technology does not distinguish between product data, and users who log on to the network can view all product-related information, and there is a risk of information leakage for enterprises. Therefore, product information security is also a problem to be solved.

The present invention uses a graphene or carbon dot labeling method for offline products to label key parts of related products. The use of the graphene and carbon dot labeling method can create an atomic-level unique identifier that cannot be reproduced so that the labeled product is unique. In addition, the labeling elements do not affect the appearance of the product and the use of normal functions.

The material signature technology is used to ensure the uniqueness of the product, the product information and the signature information are chained, and then a QR code is generated, which is engraved on the part of the product which is difficult to disassemble. The present invention can guarantee the authenticity of off-chain products, and realize the combination of on-chain and off-chain information through the QR code technology, so that originally isolated information can be combined to form a complete network and reduce losses caused by trust problems. It is convenient for users to query the corresponding public data through the QR code. Further viewing of private data requires the authorization of the product manufacturer to ensure the security of product information. When verifying the authenticity of the information, the corresponding device is used to obtain the chemically signature information, and the information is compared with the on-chain information to verify the authenticity.

Therefore, through an anti-counterfeiting system for a product anti-counterfeiting method based on a material signature blockchain of the present invention, the off-chain product and the on-chain data can be combined, and the association of the product with the on-chain data can be established through the QR code engraved on the product so as to avoid isolated on-chain information. The chemically labeling material manner is used to ensure the authenticity and uniqueness of the offline products.

The chemically labeling material manner is used to label the manufactured products, and chemical characteristics are used to ensure the uniqueness of the product, so that it can ensure the authenticity of the product when it is chained.

The QR code technology is used as a link bridge, and the QR code is used as a link to combine the on-chain information on the blockchain with the off-chain products to form a complete system. When users scan and view private data, they need to log on to the consortium blockchain, and only can view it with the appropriate permissions.

The blockchain, QR code, and chemically labeling are combined to form a complete system from off-chain to on-chain, giving full play to the advantages of each technology and ensuring the authenticity of products.

The technical principle of the present invention has been described above in conjunction with specific embodiments. These descriptions are only for explaining the principle of the present invention, and cannot be construed as limiting the protection scope of the present invention in any way. Based on the explanation here, other specific implementations of the present invention is conceivable to those skilled in the art without creative work, and these implementations will fall within the protection scope of the present invention.

What is claimed is:

1. A product anti-counterfeiting method based on a material signature blockchain, comprising:
product material signature: chemically labeling a product;
chaining of signature information and product information: detecting the signature information of the product, storing the signature information in the blockchain, and storing the product information of the product in the blockchain;
generation of a QR code: generating a QR code of the product, and engraving the QR code on a certain part of the product after the signature information and the product information are chained;
query of on-chain information: the data stored in the blockchain comprises public data and private data, on-chain users are capable of querying the public data, and on-chain users are capable of querying the private data after being authorized;
offline inspection: obtaining the signature information of the product offline, and comparing the signature information of the product obtained offline with the signature information of the product queried by the user on the chain to verify the authenticity.

2. The product anti-counterfeiting method based on a material signature blockchain of claim 1, wherein, in the material signature step of the product, a graphene labeling method or a carbon dot labeling method is used to chemically label the product.

3. The product anti-counterfeiting method based on a material signature blockchain according to claim 1, wherein the blockchain is a consortium blockchain.

4. The product anti-counterfeiting method based on a material signature blockchain according to claim 1, wherein, in the QR code generating step, after the signature information and the product information are chained, a smart contract deployed on a blockchain network automatically generates a QR code.

5. An anti-counterfeiting system for a product anti-counterfeiting method based on a material signature blockchain, comprising a product material signature module, a module of chaining signature information and product information, a module of generating a QR code, a module of querying on-chain information, and an offline inspecting module;
the product material signature module is configured to chemically label a product; the module of chaining signature information and product information is configured to detect the signature information of the product, store the signature information in the blockchain, and store the product information of the product in the blockchain;
the module of generating a QR code is configured to, after the signature information and the product information are chained, generate a QR code of the product, and engrave the QR code on a certain part of the product;
the module of querying on-chain information is configured to query the public data by on-chain users and query the private data by on-chain users after being authorized;
the offline inspecting module is configured to obtain the signature information of the product offline, and compare the signature information of the product obtained offline with the signature information of the product queried by the user on the chain to verify the authenticity.

6. The anti-counterfeiting system for a product anti-counterfeiting method based on a material signature blockchain according to claim 5, wherein the product material signature module uses a graphene labeling method or a carbon dot labeling method to chemically label the product.

7. The anti-counterfeiting system for a product anti-counterfeiting method based on a material signature blockchain according to claim 5, wherein the blockchain is a consortium blockchain.

8. The anti-counterfeiting system for a product anti-counterfeiting method based on a material signature blockchain according to claim 5, wherein the module of generating a QR code comprises a smart contract deployed on a blockchain network.
